(19) United States
(12) Patent Application Publication
(10) Pub. No.: US 2018/0242040 A1
(43) Pub. Date: Aug. 23, 2018

(54) WIRELESS HD VIDEO TRANSMISSION SYSTEM

(71) Applicant: Abylay Sargaskayev, Almaty (KZ)

(72) Inventor: Abylay Sargaskayev, Almaty (KZ)

(21) Appl. No.: 15/440,697

(22) Filed: Feb. 23, 2017

(51) Int. Cl. H04N 21/4363; H04N 7/20; H04N 21/442; H04N 21/2343; H04N 21/44

(52) U.S. Cl. CPC H04N 21/43637; H04N 21/43635; H04N 21/44; H04N 21/44227; H04N 21/2343; H04N 7/20

(57) ABSTRACT

The wireless video transmission system comprises a video stream source and a transmitting part. The transmitting part is coupled with the video stream source and configured to receive a video stream and wirelessly transmit a data stream based on the video stream using two or more radio channels. The transmitting part comprises a dividing evaluator and a wireless data transmission system. The wireless data transmission system is coupled with the coupling evaluator and configured to receive a data stream based on the video stream and wirelessly transmit the data stream using the two or more radio channels.

### BACKGROUND

A process of wireless video stream transmission can be characterized by the following features: system bandwidth, data delay. There are many different embodiments of wireless data transmission. Each embodiment has its own features and advantages, but none have high bandwidth with low data generation time delay and transmission delay. Wireless data transmission allows one to transfer video streams of high resolution and high frame rate with minimum delay. A feature of this data transmission process is the absence of video stream compression that allows making the generation and wireless data transmission time invariant with respect to the size of the transmitting video stream.

Prior known systems are able to work with resolutions of up to 2160×1200 and clock frequencies not exceeding 90 Hz.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. The principles of work and functioning of the invention can be described by the following figures and diagrams:

FIG. 1 is a high-level block diagram of a system according to an embodiment;

FIG. 2 is a functional block diagram of a transmitting part of FIG. 1 according to an embodiment;

FIG. 3 is a functional block diagram of a receiving part of FIG. 1 according to an embodiment;

FIG. 4 is a high-level process flow diagram of a method according to an embodiment;

FIG. 5 is a functional block diagram of operation of a system according to an embodiment;

FIG. 6 is a process flow diagram of video stream dividing according to an embodiment;

FIG. 7 is a process flow diagram of data streams coupling according to an embodiment; and

FIG. 8 is a block diagram of a computer system in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

A distinctive feature of the solution used in one or more embodiments of the present invention is the use of WirelessHD standard for wireless data transmission, which operates at a frequency of 60 GHz. The WirelessHD standard refers to the standard for wireless high definition video transmission available at http://www.wirelesshd.org/. This frequency range is not widely used, which enables a stable work in this frequency of one or more embodiments according to the present invention. Stable work is intended to include a low number of users of the radio resource allowing transmission of data with minor data transmission errors. Also, the decrease of transmitted data volume in one communication channel using division of the video stream to several channels, allows transmission of the video having a resolution having a bandwidth of up to 36 Gigabits per second (Gb/s). In at least some embodiments, the video transmission has a resolution of up to 3840×2160 and a frame rate of up to 120 Hz.

Video stream is intended to include the time sequence of frames of a certain format, encoded in a bit stream.

Data stream is intended to include the time sequence of bits that identify information.

System bandwidth is intended to include the amount of data able to be processed per second by the system.

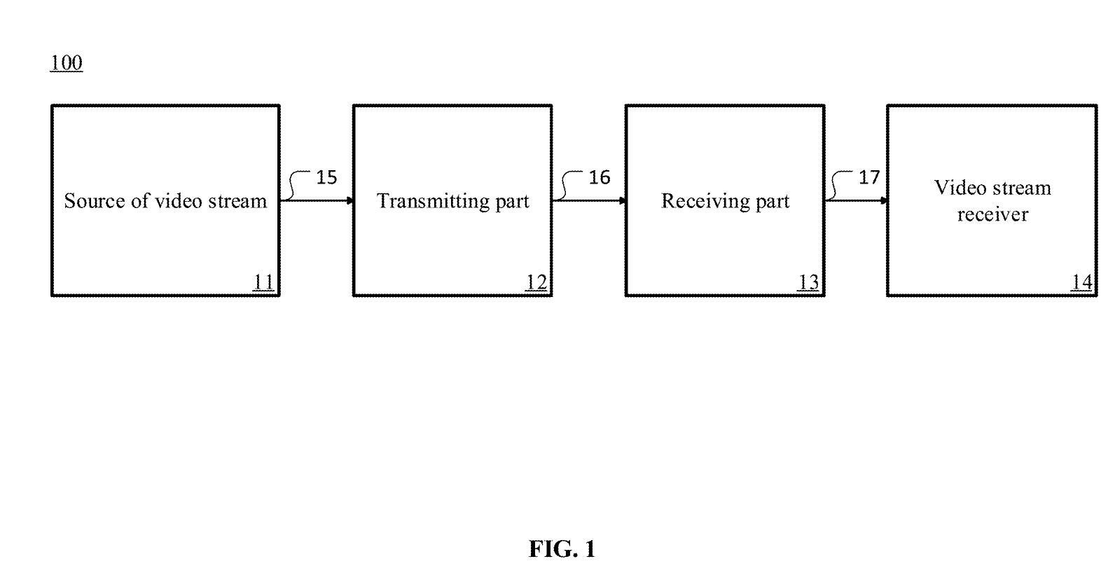

FIG. 1 is a high-level block diagram of a system 100 according to an embodiment. The system 100 comprises a video stream source 11, a transmitting part 12 and a receiving part 13 and a video stream receiver 14. In accordance with one or more embodiments, video stream source 11 is one or more of the following: personal computer, laptop (notebook, tablet), Apple products (IPhone, IPod, IPad), mobile phone, game console (X-BOX, PlayStation, Wii, Sega, Nintendo etc.), DVD-player, Blue-ray player, receiver of satellite TV systems, IP-camera, machine vision systems, or like systems. The video stream source 11 generates the input of the transmitting part 12 of the system 100, i.e., the video stream, which may be provided by various interfaces 15, where the following standards act as an interface: HDMI, DisplayPort, DVI, USB, or like interfaces. The format of the video stream is one or more of the formats in the VESA standard, required capacity of which does not exceed 12 Gb/s. The transmitting part 12 converts the video stream into a data stream for further transmission by wireless communication systems 16. Wireless communication system 16 is one or more of the following: WirelessHD, Wireless Home Digital Interface and Wireless Gigabit Alliance, or like standards. Wireless communication system 16 implements wireless data stream transmission to the receiving part 13. In turn, the receiving part 13 receives the data stream and performs an inverse transformation into the video stream. The video stream is transmitted to the receiver 14 which, according to one or more embodiments, is one or more of the following devices: monitor, TV, projector, personal computer, laptop (notebook, tablet), Apple products (iPhone, iPod, iPad), mobile phone, virtual reality glasses (goggles), augmented reality glasses (goggles), digital display, or the like. In one or more embodiments, the video stream transmission is implemented through various interfaces 17. In accordance with one or more embodiments, one or more of the following standards are used as the interface: HDMI, DisplayPort, VGA, DVI, USB, or the like.

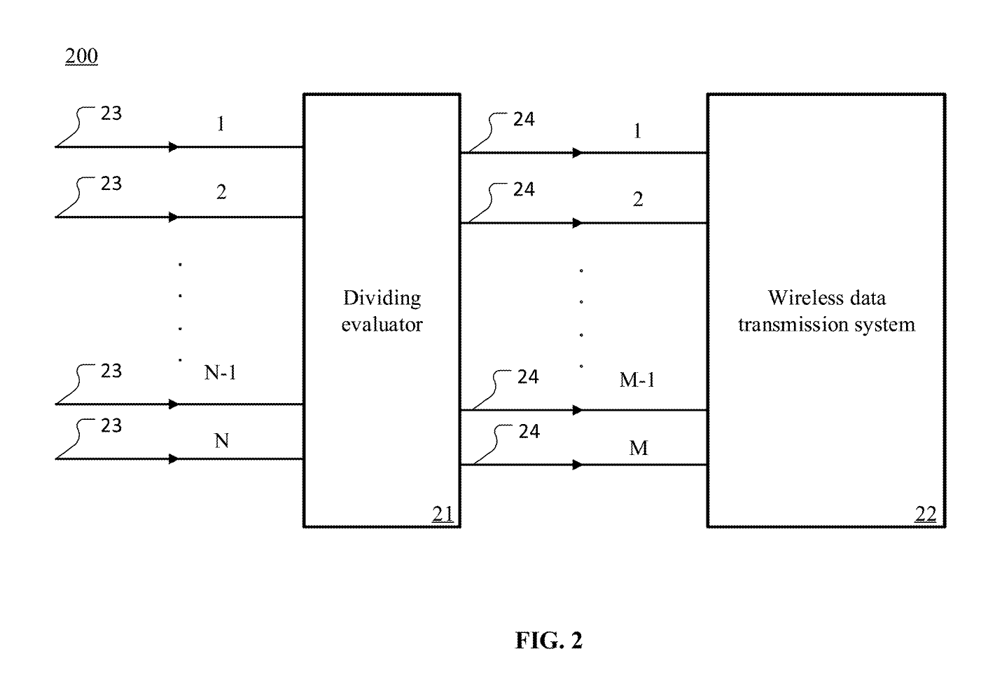

FIG. 2 is a functional block diagram of the transmitting part 12 of FIG. 1 according to an embodiment. The transmitting part 12 of the system 100 comprises a dividing evaluator 21 and a wireless data transmission system 22. The dividing evaluator 21 is implemented as one or more of the following devices: FPGA, GPU, CPU, DSP processor, microcontroller, or the like. The task of the dividing evaluator 21 is to receive N video streams 23 from the source and convert them into M data streams 24 which then are transmitted to the receiving part of the system by wireless data transmission system 22.

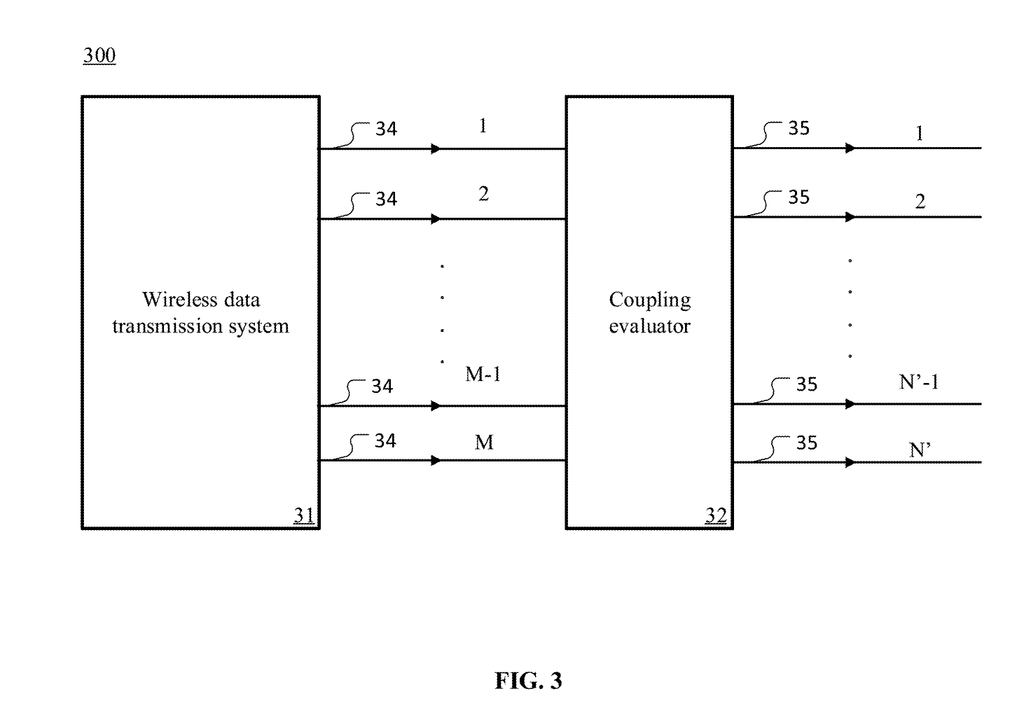

FIG. 3 is a functional block diagram of the receiving part 13 of FIG. 1 according to an embodiment. The receiving part 13 of the system 100 comprises a coupling evaluator 32 and a wireless data transmission system 31. The coupling evaluator 32 is implemented as one or more of the following devices: FPGA, GPU, CPU, DSP processor, microcontroller, or the like. The task of coupling evaluator 32 is to convert M data streams 34 into N′ video streams 35 and transmit them to the video stream receiver 14.

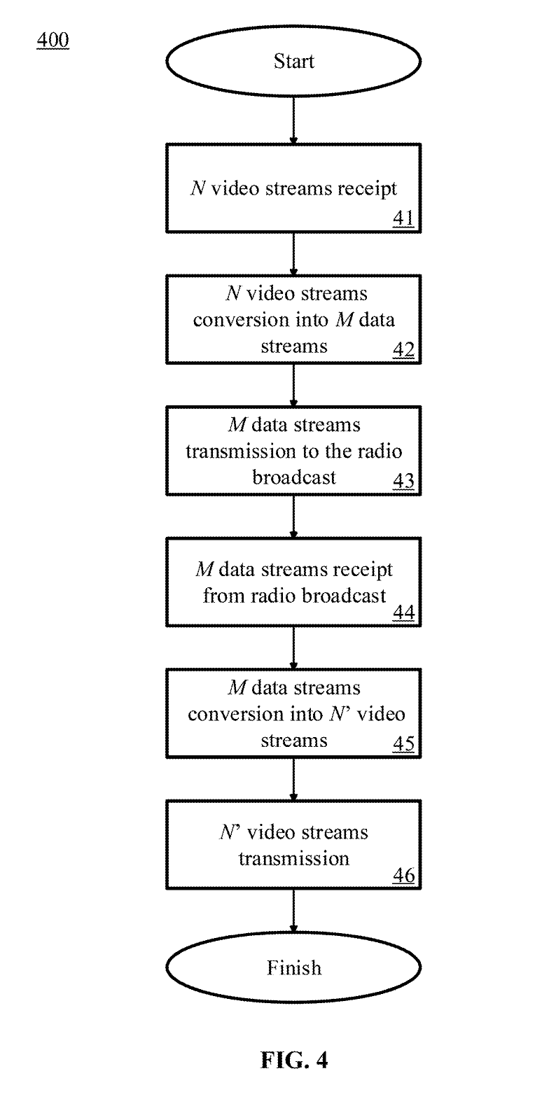

FIG. 4 is a high-level process flow diagram of a method according to an embodiment. The process flow comprises the following steps: first, the system receives the N video streams 41 which are part of a single video stream, divided at the source of the video data. Then, N (N=0 . . . n, where n—number of sources of video streams) video streams are transformed into M (M′=0 . . . m, where m—number of a wireless data transmission channels) data streams 42 with a redistribution of the volume of transmitted data to each of the data streams. After, the data streams are transmitted to the radio broadcast 43. From there, the data is received by the receiving part 44. Then, the M data streams are coupled into N′ (N′=0 . . . k, where k—number of receivers) video streams 45 in accordance with the data stream division algorithm and receiver configuration, and are transmitted to the receiver 46.

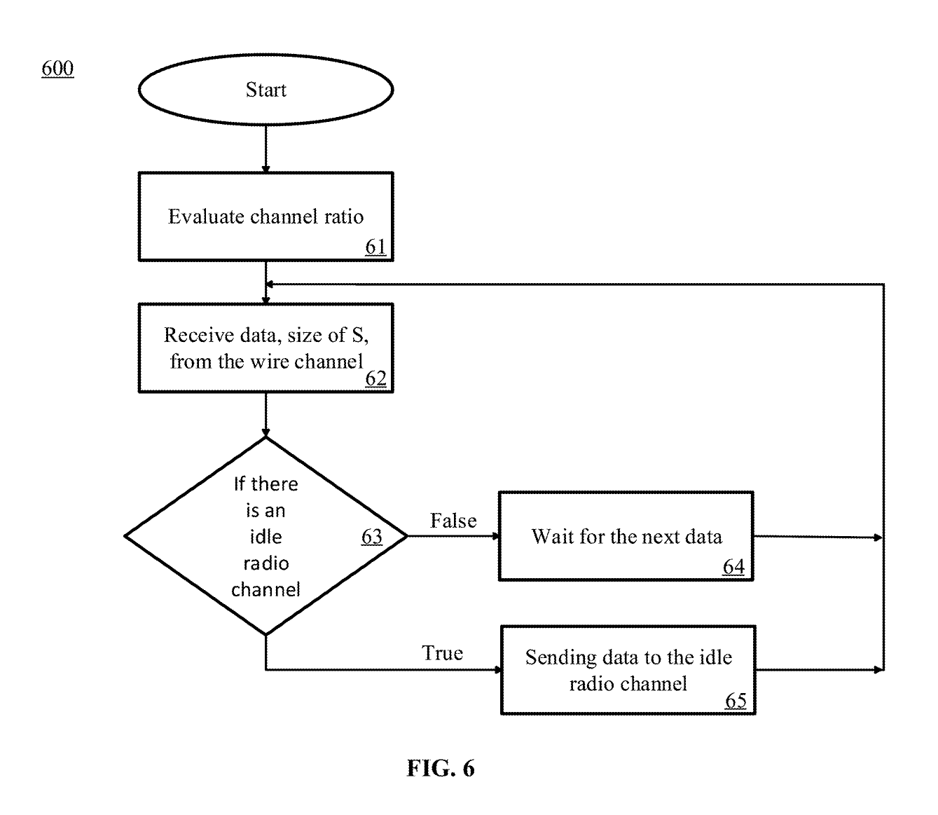

FIG. 6 is a process flow diagram of video stream dividing according to an embodiment. The dividing process comprises the following steps: the system has two bandwidths:

Nwire is a bandwidth of a single wire channel; and

Nrf is a bandwidth of a single wireless channel.

At the first step of the dividing process, the process evaluates the channel ratio M 61 (determines how many radio channels are available for use to transmit the whole video data, i.e., transmission of the video data without loss of visual information), then the process receives a video stream size of S 62. The channel ratio M is used to determine an amount of radio channels usable to transmit the current video data with a given resolution and frame rate, i.e., the required bandwidth. This evaluation is performed because the bandwidth of the radio channel is constant but the bandwidth of the current resolution is variable. An amount of data is determined by the control signals in accordance with the Video Electronics Standard Association (VESA) standard (available at https://www.vesa.org/). Next, the process searches for an idle radio channel 63 and sending data to the channel 65. If there is no idle radio channel, the process waits for the next video stream's part 64.
S is a parameter of the dividing algorithm. S represents how much data in bits will transmit through a single radio channel in one process iteration (turn); S is the size of one data block. The product of M and S, i.e., M*S, is the amount of data sendable in one iteration, i.e., one frame. This value represents a threshold for the number of bits which can be transmitted through one radio channel in one iteration.

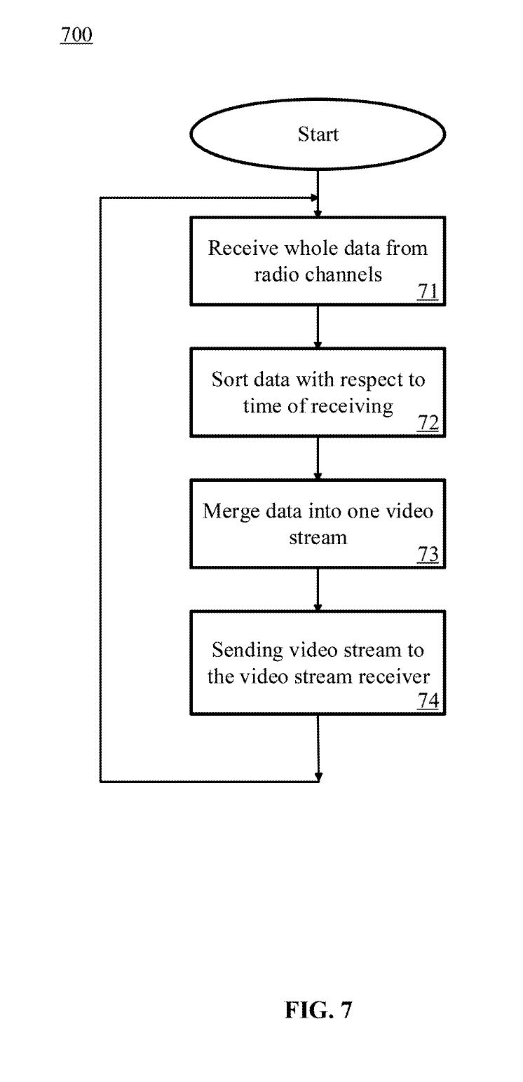

FIG. 7 is a process flow diagram of data stream coupling according to an embodiment. Each package on a radio channel has a time stamp which shows the data stream package's receipt time. In accordance with at least one embodiment, the receiver in the wireless communication system applies the time stamp, e.g., by adding at the end of each package several bytes which represent the time. The radio channel is intended to include a part of the wireless communication system which operates with and transmits certain data streams. During the first step, the coupling process receives data from all of the radio channels 71. Further, coupling evaluator 32 sorts radio channel data with respect to a time stamp 72. Then, coupling evaluator 32 merges all data from radio channels into one video stream 73 and transmits the video stream to the video stream receiver 74.

### Example

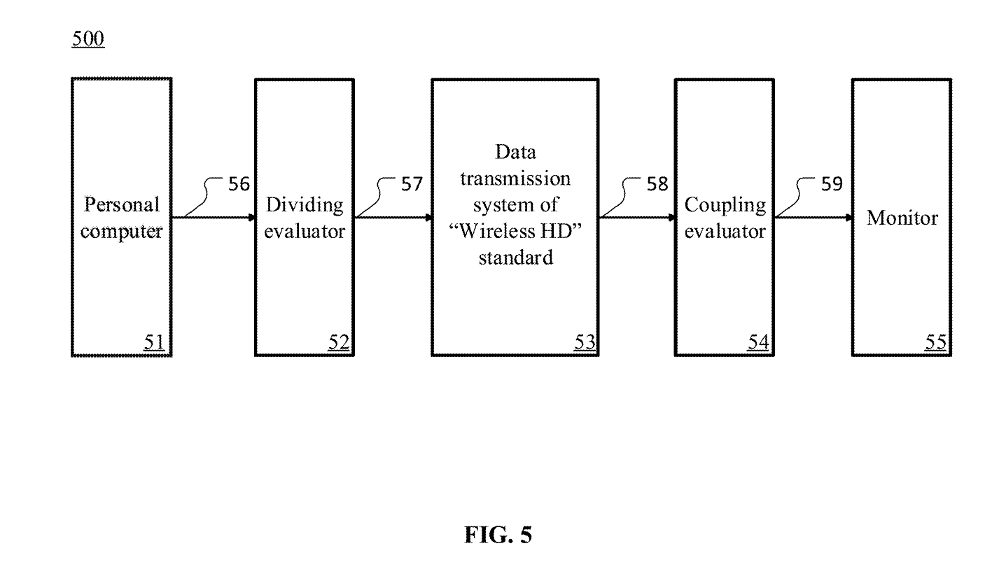

As an example embodiment of the present invention, the following implementation is represented in FIG. 5 in accordance with FIG. 1. In this embodiment, a personal computer 51 is used as the video source that generates two video streams entering the transmitting part through two HDMI lines 56. On the transmitting part, the dividing evaluator 52 is in the form of an FPGA that implements time division of each video stream into two data streams. This separation technique comprises the following: the even frames of each video stream are transmitted in the first data stream and odd frames of each video stream are transmitted in the second data stream.

In a more general way, every Nth frame is transmitted in the Nth radio channel. For example, in another embodiment, 4 radio channels per one wire channel are used, so in accordance with the embodiment, the first frame will be transmitted through the first radio channel, the second frame will be transmitted through the second radio channel, and so on.

This method enables reduction of the required bandwidth of each of the radio channels used by the wireless data transmission system. Four data streams 57 generated by dividing evaluator 52 are transferred to the wireless data transmission system 53 which, using WirelessHD standard, transmits data streams to the receiving part of the wireless data transmission system 53 where, after receiving by the wireless data transmission system from broadcast, four data streams 58 are transferred to coupling evaluator 54. In the coupling evaluator, based on the division process explained above, four data streams are coupled into 2 video streams. The coupling evaluator in this embodiment is an FPGA. The generated video streams are received by the video stream receiver, which in this embodiment is a monitor with two HDMI lines 59. In this embodiment, the input 56 and output 59 video streams are any resolution which has a bandwidth of up to 36 Gigabits per second (Gb/s). In at least one embodiment, input 56 and output 59 video streams are a single video with resolution of 3840×2160, color depth of 8 bits per color channel and frame rate frequency of 120 Hz. Each individual video stream of channel 56, 59 is a video with resolution of 1920×2160, color depth of 8 bits per channel and frame rate frequency of 120 Hz.

One or more embodiments according to the present invention generate wireless video streams transmission at resolutions of up to 3840×2160 (8294 k) pixels, using a depth of 8 bits per color channel and image frame rate of 120 Hz with fixed delay of not more than 5 ms.

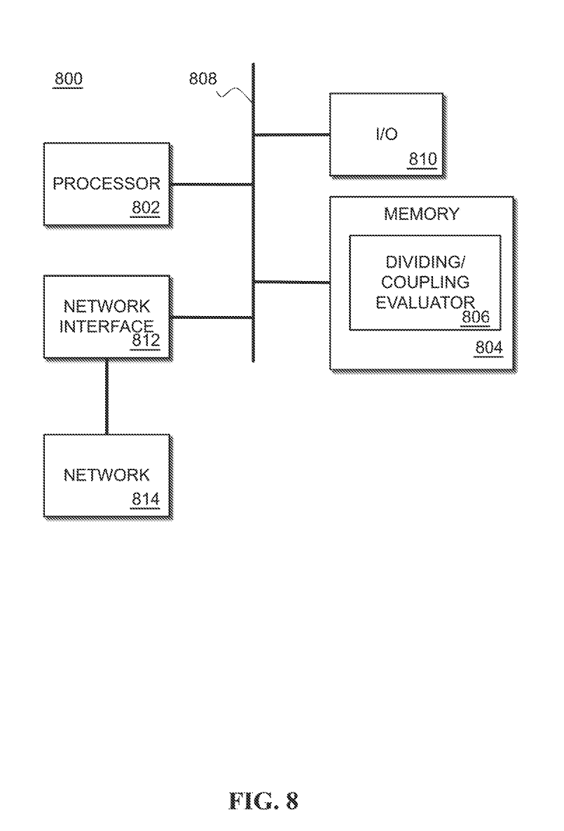

FIG. 8 is a block diagram of computer system 800 in accordance with some embodiments. Computer system 800 is usable as one or more of transmitting part 12, receiving part 13, dividing evaluator 21, and/or coupling evaluator 32.

At least a portion of the method of flowcharts of FIGS. 6-7 are implemented, for example, using computer system 800, in accordance with some embodiments.

In some embodiments, computer system 800 is a general purpose computing device including a hardware processor 802 and a non-transitory, computer-readable storage medium 804. Storage medium 804, amongst other things, is encoded with, i.e., stores, computer program code 806, i.e., a set of executable instructions. Execution of instructions 806 by hardware processor 802 represents (at least in part) a dividing and/or coupling evaluator which implements a portion or all of, e.g., the method of dividing and/or coupling a video stream/data stream, e.g., in the method of FIGS. 6-7, in accordance with one or more embodiments (hereinafter, the noted processes and/or methods).

Processor 802 is electrically coupled to computer-readable storage medium 804 via a bus 808. Processor 802 is also electrically coupled to an I/O interface 810 by bus 808. A network interface 812 is also electrically connected to processor 802 via bus 808. Network interface 812 is connected to a network 814, so that processor 802 and computer-readable storage medium 804 are capable of connecting to external elements via network 814. Processor 802 is configured to execute computer program code 806 encoded in computer-readable storage medium 804 in order to cause system 800 to be usable for performing a portion or all of the noted processes and/or methods. In one or more embodiments, processor 802 is a central processing unit (CPU), a multi-processor, a distributed processing system, an application specific integrated circuit (ASIC), and/or a suitable processing unit.

In one or more embodiments, computer-readable storage medium 804 is an electronic, magnetic, optical, electromagnetic, infrared, and/or a semiconductor system (or apparatus or device). For example, computer-readable storage medium 804 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 804 includes a compact disk-read only memory (CD-ROM), a compact disk-read/write (CD-R/W), and/or a digital video disc (DVD).

In one or more embodiments, storage medium 804 stores computer program code 806 configured to cause system 800 (where such execution represents (at least in part) the dividing evaluator/coupling evaluator) to be usable for performing a portion or all of the noted processes and/or methods. In one or more embodiments, storage medium 804 also stores information which facilitates performing a portion or all of the noted processes and/or methods.

In some embodiments, computer system 800 includes an I/O interface 810. I/O interface 810 is coupled to external circuitry. In one or more embodiments, I/O interface 620 includes a keyboard, keypad, mouse, trackball, trackpad, touchscreen, and/or cursor direction keys for communicating information and commands to processor 802. In some embodiments, computer system 800 does not include I/O interface 810.

Computer system 800 also includes network interface 812 coupled to processor 802. Network interface 812 allows system 800 to communicate with network 814, to which one or more other computer systems are connected. Network interface 812 includes wireless network interfaces such as BLUETOOTH, WIFI, WIMAX, GPRS, WCDMA or other suitable networks supporting the WirelessHD standard or other wireless video transmission standards; or wired network interfaces such as ETHERNET, USB, or IEEE-1364. In one or more embodiments, a portion or all of noted processes and/or methods, is implemented in two or more systems 800.

In some embodiments, system 800 is configured to receive information through I/O interface 810. The information received through I/O interface 810 includes one or more of instructions, data, and/or other parameters for processing by processor 802. The information is transferred to processor 802 via bus 808. Computer system 800 is configured to receive information related to a UI through I/O interface 810. The information is stored in computer-readable medium 804 as user interface (UI) 842.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of a dividing/coupling evaluator. In some embodiments, a portion or all of the noted processes and/or methods is implemented as a software application that is used by computer system 800.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

At least one embodiment comprises a wireless video transmission system. The wireless video transmission system comprises a video stream source and a transmitting part. The transmitting part is coupled with the video stream source and configured to receive a video stream and wirelessly transmit a data stream based on the video stream using two or more radio channels. The transmitting part comprises a dividing evaluator and a wireless data transmission system. The wireless data transmission system is coupled with the dividing evaluator and configured to receive a data stream based on the video stream and wirelessly transmit the data stream using the two or more radio channels.

At least one embodiment comprises a wireless video reception system. The wireless video reception system comprises a receiving part and a video stream receiver. The receiving part is configured to wirelessly receive a data stream using two or more radio channels. The video stream receiver is coupled with the receiving part and configured to receive a video stream and display the received video stream. The receiving part comprises a wireless data transmission system and a coupling evaluator. The wireless data transmission system is configured to receive a data stream using two or more radio channels. The coupling evaluator is coupled with the wireless data transmission system and configured to receive the data stream and generate the video stream.

At least one embodiment comprises a method of wireless video transmission. The method comprises converting N received video streams into M data streams; transmitting the M data streams in parallel via a wireless broadcast (shown in at least FIG. 2 in the parallel transmission lines 24); converting the M received data streams into N′ video streams; and displaying the N′ video streams.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A wireless video transmission system, comprising:
a video stream source; and
a transmitting part coupled with the video stream source and configured to receive a video stream and wirelessly transmit a data stream based on the video stream using two or more radio channels, the transmitting part comprising:
a dividing evaluator, wherein the dividing evaluator is configured to determine a channel ratio based on a number of radio channels available for transmission of the data stream and a bandwidth of the video stream; and
a wireless data transmission system coupled with the dividing evaluator and configured to receive a data stream based on the video stream and wirelessly transmit the data stream using the two or more radio channels.

2. (canceled)

3. The wireless video transmission system of claim 3, wherein the dividing evaluator is configured to divide the video stream into data packages for transmission based on the channel ratio.

4. A wireless video reception system, comprising:
a receiving part configured to wirelessly receive a data stream using two or more radio channels; and
a video stream receiver coupled with the receiving part and configured to receive a video stream and display the received video stream, the receiving part comprising:
a wireless data transmission system configured to receive a data stream using two or more radio channels; and
a coupling evaluator coupled with the wireless data transmission system and configured to receive the data stream and generate the video stream, wherein the coupling evaluator is configured to generate the video stream from the two or more radio channels and based on a channel ratio.

5. A method of wireless video transmission, the method comprising:
converting N received video streams into M data streams, wherein the converting is performed based on a channel ratio based on a number of channels available for transmission of the M data streams and a bandwidth of the N received video streams;
transmitting the M data streams in parallel via a wireless broadcast;
converting the M received data streams into N′ video streams; and
displaying the N′ video streams.
